(19) United States
(12) Patent Application Publication
(10) Pub. No.: US 2020/0198108 A1
(43) Pub. Date: Jun. 25, 2020

(54) CHUCK KEY FOR USE WITH STANDARD TOOLS

(71) Applicant: Wade Dean, Brighton, MI (US)

(72) Inventor: Wade Dean, Brighton, MI (US)

(21) Appl. No.: 16/344,560

(22) PCT Filed: Sep. 13, 2018
(86) PCT No.: PCT/US18/50954

§ 371 Date: Apr. 24, 2019

Related U.S. Application Data
(60) Provisional application No. 62/558,735, filed on Sep. 14, 2017.

(51) Int. Cl. B25B 33/00; B23B 45/00

(52) U.S. Cl. CPC B25B 33/005; B23B 45/006

(57) ABSTRACT

A chuck key for tightening the jaws of a drill chuck of a chuck is disclosed. The chuck key includes, a pin for engaging the chuck, a gear having a plurality of cogs arranged concentrically around a central axis for engaging cogs of the chuck, wherein the gear includes a cavity having a same center of axis as the gear, a protrusion opposite the pin, wherein the protrusion includes an aperture.

### CROSS REFERENCE TO RELATED APPLICATIONS

This application claims the benefit of Provisional Application No. 62/558,735 filed on Sep. 14, 2017 which is hereby incorporated herein by reference.

### TECHNICAL FIELD

This disclosure relates to chuck keys, and more particularly to chuck keys for drills or other mechanical tools.

### BACKGROUND

The statements in this section merely provide background information related to the present disclosure and may not constitute prior art.

Drill chuck keys have long been used to close the jaws/collets of a drill chuck on a cutting bit to hold the bit in place during the cutting operation. A traditional chuck key gear has a pin for alignment with the pilot hole of a chuck extending from the narrow diameter of the gear, and adjacent the wider diameter of the gear a protrusion of a shaft with hole for a T-handle at the opposing end. Chucks and chuck keys come in different sizes, and the chuck keys typically with a T or L-handle. It is common to use a T-handle chuck key to tighten or loosen the chuck about a bit.

Conventional chuck keys are typically formed with a T-handle with somewhat limited lateral dimensions thus severely restricting the leverage which might be applied to the key during tightening of the chuck. Consequently, in practice, the workmen frequently leave the chuck in an only partially tightened condition resulting in bit slippage when substantial forces are encountered during the cutting process. Moreover, the failure to tighten a cutting bit forcing the cutting tool into positive axial alignment, oftentimes leaves the cutting tool out of axial alignment with the chuck thus oftentimes leading to an inaccurate cut and resultant waste of the work stock. Other times, when the chuck is fully tightened during the tightening process, when it becomes time to remove the cutting tool, a conventional key does not provide sufficient leverage for convenient loosening of the chuck thus necessitating the workman resorting to tools such as pliers or wrenches to engage the chuck key for the necessary mechanical advantage of loosening the chuck.

Known chuck keys are disadvantaged in that the rotational torque required to tighten and to loosen a chuck about a bit can be difficult to apply. It is common for those who use a chuck key to use vice grips, channel lock pliers, crescent wrench, and other means to get a better grip on a chuck key for a rotational torque advantage to securely tighten a bit in a chuck. In some cases, operators will use a hammer to strike a chuck key or a screwdriver to tighten or loosen a chuck about a bit. It is not uncommon for an operator to use a boxed end wrench engaged with the T-handle of a chuck key to gain a rotational torque advantage, and this often will result in bent T-handles.

The handles of known standard hand-held tools such as a ¼-inch drive, or ⅜-inch drive, or ½-inch drive socket ratchet handle are considerably longer in length than the length of known chuck key handles, whether it be a T or L-handle.

Therefore, a new chuck key is needed that can engage with known standard hand-held tools to increase rotational torque for application to chucks.

### SUMMARY

A chuck key for tightening the jaws of a drill chuck of a chuck is disclosed. The chuck key includes, a pin for engaging the chuck, a gear having a plurality of cogs arranged concentrically around a central axis for engaging cogs of the chuck, wherein the gear includes a cavity having a same center of axis as the gear, a protrusion opposite the pin, wherein the protrusion includes an aperture.

Certain embodiments of the invention include the aperture opening into the cavity. The cavity being a different shaped void than the aperture. In one embodiment, the aperture is square-shaped opening into a hexagonal-shaped cavity.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 shows an exemplary chuck key, in accordance with the present disclosure;

FIG. 2 is a cross-sectional view of the chuck key, in accordance with the present disclosure;

FIGS. 3A-3C are embodiments of the chuck key with varying gear and protrusion sizes, in accordance with the present disclosure;

FIG. 3D is a top plan view of an embodiment of the chuck key, in accordance with the present disclosure;

FIG. 3E is a side view of an embodiment of the chuck key, in accordance with the present disclosure;

FIG. 3F is a bottom plan view of an embodiment of the chuck key, in accordance with the present disclosure;

FIGS. 4A-4D shows an embodiment of the chuck key having an enlarged protrusion, in accordance with the present disclosure;

FIGS. 5A-5D shows an embodiment of the chuck key without a protrusion and with the cavity and the aperture within the gear, in accordance with the present disclosure;

FIGS. 6A-6D shows an embodiment of the chuck key without a protrusion and without the aperture, in accordance with the present disclosure;

FIGS. 7A-7D shows an embodiment of the chuck key with an enlarged protrusion, in accordance with the present disclosure;

FIGS. 8A-8C shows an embodiment of a protrusion separate from the chuck key, in accordance with the present disclosure;

FIGS. 9A-9C shows another embodiment of a protrusion separate from the chuck key, in accordance with the present disclosure; and

FIGS. 10A and 10B illustrate an exemplary embodiment of the chuck key without the gears, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

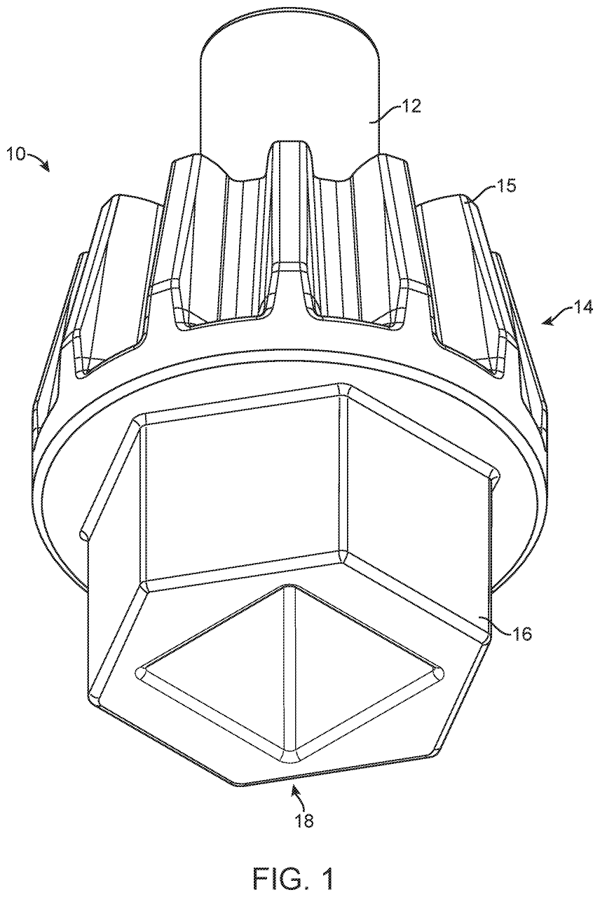

Referring now to the drawings, wherein the depictions are for the purpose of illustrating certain exemplary embodiments only and not for the purpose of limiting the same, FIG. 1 schematically shows an exemplary chuck key 10 for a mechanical tool. The exemplary chuck key 10 is formed of a chuck pin 12, an axially aligned a concentric tapered circular bevel gear 14, and an axially aligned a hex-shaped protrusion 16 opposite the chuck pin 12. The protrusion 16 preferably is formed of larger diameter, in cross section, than the pin 12. The pin 12 is generally circular in cross-section, but may vary in size and shape depending on the particular receiving portion of the chuck.

The bevel gear 14 may be formed of any number of cogs 15 depending on the particular chuck of the mechanical tool it is intended to be engaged with. The hex-shaped protrusion 16 preferably includes a first aperture, i.e., a socket 18, for receiving a drive of a socket wrench or similar mechanical tool. The socket 18 may be square-shaped, as shown in FIGS. 1 and 2, or any other shape having 3 or more sides. In one embodiment, the first aperture 18 opens into a cavity i.e., a second aperture 20.

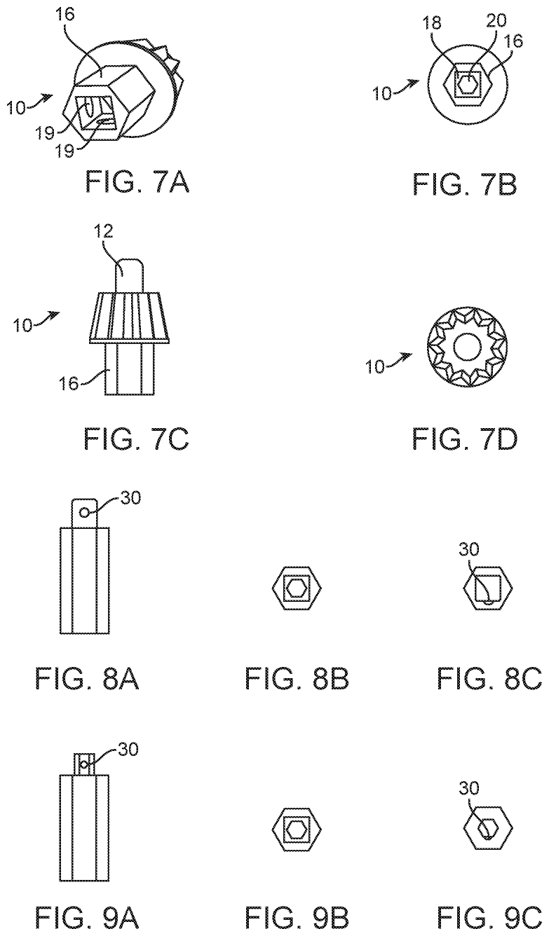

As shown in cross-sectional view of FIG. 2 and the top view of FIG. 7B, the second aperture 20 is hex-shaped, although it is contemplated herein that the aperture 20 may be one of any number of shapes including triangles, quadrilateral including rhomboidal shapes and diamond shapes, pentagonal, hexagonal, heptagonal, octagonal or oval. In one embodiment, side walls of the first aperture 18 include ball detents 19 which may be sized and shaped for engagement by the spring-loaded balls of a socket wrench drive lug to releasably lock the drive lug in the aperture 18. As shown, the second aperture 20 is within a body of the bevel gears 14.

The chuck key 10 is preferably of integral construction via machining during the manufacturing process. In one embodiment, the bevel gear 14 may be welded to the protrusion 16. In one embodiment, the protrusion 16 is welded to the top surface of the bevel gear.

In use, the chuck key 10 may be engage within: (1) the outside of the protrusion 16 via a socket bit; (2) the inside of the first aperture 18 via a square drive of a socket wrench and similar related mating tools such as a breaker bar or a socket wrench extension; or (3) the inside of the second aperture 20 via an alien wrench or other hex-shaped bits. It is contemplated herein that a specialized custom bit may be fabricated that would engage the chuck key 10 at more than one location, e.g., at both the outside of the protrusion 16 and the inside of either the first or second apertures 18 and 20 or, at both the first and second apertures 18 and 20.

When engaged with a socket wrench having a square drive at the first aperture 18, locking balls of the socket wrench may engage at the detents 19, thereby removably securing the square drive. The pin 12 of the key 10 is then inserted into the pin bores of the chuck of the mechanical tool (not shown). When the pin 12 is inserted, the bevel gear 14 engages with the beveled gears formed at the end of the chuck collar. The user may then rotate the socket wrench to tighten or loosen a chuck collar on the mechanical tool to draw collets down on a shank of a bit within the chuck or to move the collets away from the shank of the bit to loosen.

It is to be understood that alternative mechanical tools may be engage to the chuck key 10 including, for example, standard hand drive tools such as breaker bars, socket ratchets, and ratchet attachments such as extensions, sockets, and conventional socket bits. In some embodiments, the chuck key 10 accepts, standard hand wrench types such as open-end wrenches, allen wrench, boxed end wrenches, open end wrenches, crescent wrenches and other similar wrench types. A socket wrench or other tool may be used in conjunction with the hex bits when engaging the second aperture 20.

One skilled in the art will recognize that if the second aperture 20 is differently shaped, a correspondingly shaped bit would be needed to engage therein, e.g., diamond, pentagon, hexagon, and multi-pointed star shaped bits.

The chuck key 10 is designed to increase rotational torque to a chuck collar by communicating torque from a connection with the hand tool, and this communication can be an internal connection to or with the chuck key gear body, or an external connection adjacent the gear body of the chuck.

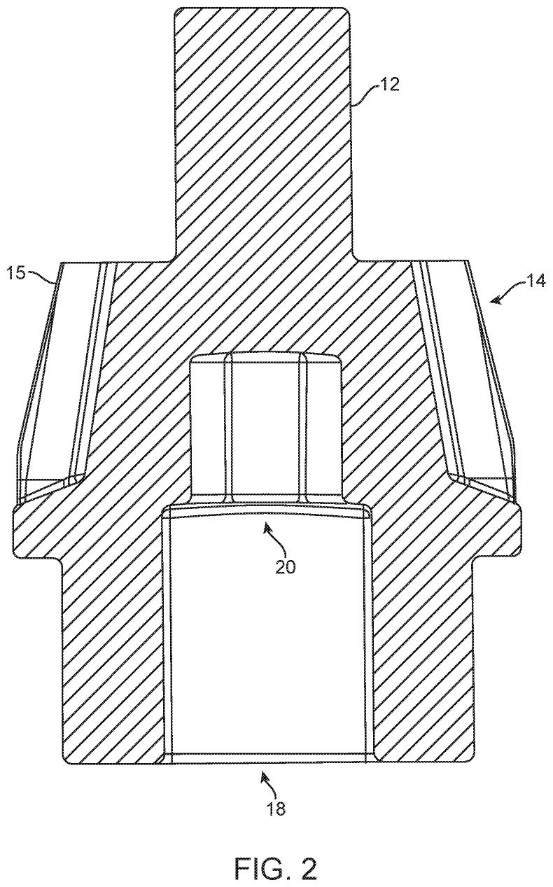

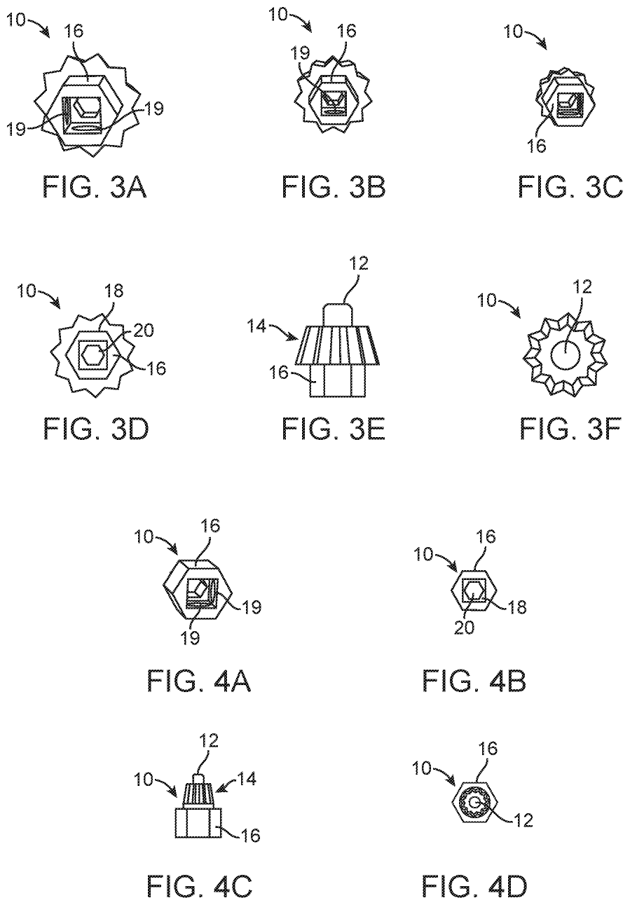

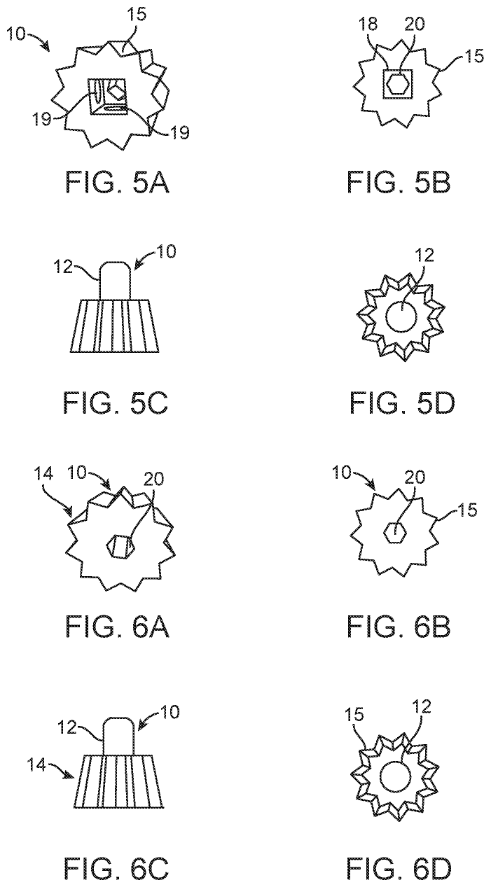

The hex shaped protrusion 16 adjacent the wide portion of the gear body 14 of a chuck key and the gear body can be one piece as shown in FIGS. 1-2, and FIGS. 3A-3F, FIGS. 4A-4D, and FIGS. 7A-7D. In one embodiment, the protrusion 16 may be omitted and the first and second apertures 18 and 20 may be incorporated within the body of the gears 14 such as shown in FIGS. 5A-5D. In one embodiment, first aperture 18 and the protrusion 16 may be omitted from the key 10 and only the second aperture 20 included within the gears 14 such as shown in FIGS. 6A-6D.

In yet another embodiment, the protrusion 16 can be detachable from the gear body 14 of the chuck key 10 as illustrated in FIGS. 8A-8C, and FIGS. 9A-9C. FIGS. 8A-8C show a standard square protrusion with spring loaded retention ball 30 at one end, and at the opposing end openings to receive standard hand tools. FIGS. 8A-8C being the preferred embodiment of the detachable hex protrusion. FIGS. 9A-9C shows a standard hex protrusion with spring loaded retention ball 30 at one end, and at the opposing end openings to receive standard hand tools. With the hex shaped protrusion detached from the gear body 14, the chuck key 10 is still compatible with a variety of common hand tools, yet not limited to a socket ratchet, socket ratchet extension, breaker bar, socket with hex bit, and allen wrench as illustrated in the drawings.

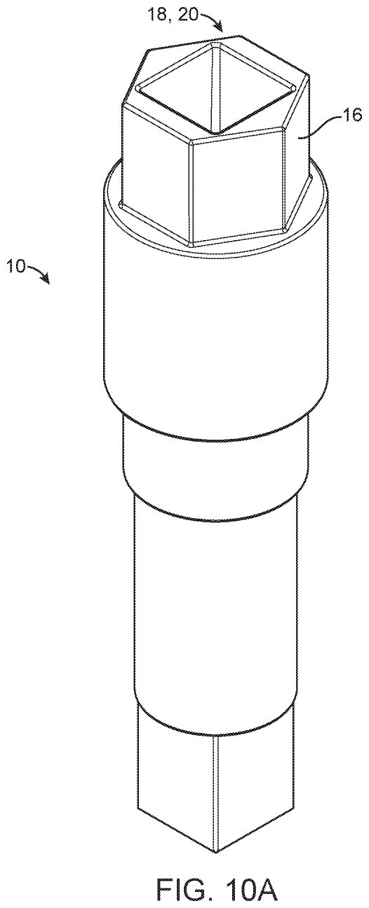

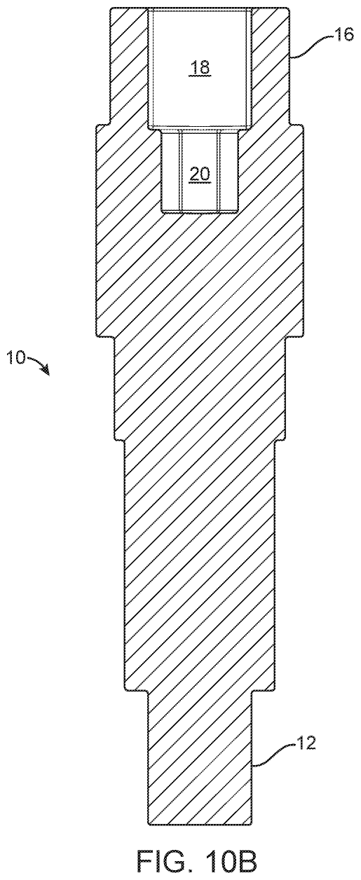

FIGS. 10A and 10B illustrate an exemplary embodiment of the chuck key 10 without the gears.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A chuck key for tightening the jaws of a drill chuck of a chuck, comprising:
a pin for engaging the chuck;
a gear having a plurality of cogs arranged concentrically around a central axis for engaging cogs of the chuck, wherein the gear includes a cavity having a same center of axis as the gear;
a protrusion opposite the pin, wherein the protrusion includes an aperture; and
wherein the protrusion, the aperture, the gear, and the pin have a same center of axis.

2. The chuck key of claim 1, wherein the gear comprises a cavity differently shaped than the aperture of the protrusion.

3. The chuck key of claim 2, wherein the cavity is formed of more than four sidewalls.

4. The chuck key of claim 2, wherein the cavity is formed of five sidewalls to form a pentagonal shape.

5. The chuck key of claim 2, wherein the cavity is formed of six sidewalls to form a hexagonal shape.

6. The chuck key of claim 2, wherein the cavity comprises a star shape.

7. The chuck key of claim 2, wherein the aperture opens into the cavity.

8. The chuck key of claim 7, wherein the cavity forms of one of a triangle shape, a quadrilateral shape, a pentagonal shape, a hexagonal shape, a heptagonal shape, an octagonal shape, and an oval shape.

9. The chuck key of claim 7, wherein the aperture forms of one of a triangle shape, a quadrilateral shape, a pentagonal shape, a hexagonal shape, a heptagonal shape, an octagonal shape, and an oval shape.

10. A chuck key for tightening the jaws of a drill chuck of a chuck, comprising:
a pin for engaging the chuck;
a bevel gear having a plurality of cogs arranged concentrically around a central axis for engaging cogs of the chuck, wherein the gear includes a cavity having a same center of axis as the gear;
a protrusion opposite the pin, wherein the protrusion comprises more than four exterior sidewalls and an aperture; and
wherein the protrusion, the gear, and the pin have a same center of axis.

11. The chuck key of claim 10, wherein the aperture of the protrusion opens into the cavity, and the cavity is differently shaped than the aperture of the protrusion, and wherein the cavity includes a base wall 90-degrees from a sidewall.

12. The chuck key of claim 10, wherein the cavity is formed of more than four sidewalls.

13. The chuck key of claim 10, wherein the cavity is formed of five sidewalls to form a pentagonal shape.

14. The chuck key of claim 10, wherein the cavity is formed of six sidewalls to form a hexagonal shape.

15. The chuck key of claim 10, wherein the cavity comprises a star shape.

16. The chuck key of claim 10, wherein the aperture opens into the cavity.

17. The chuck key of claim 16, wherein the cavity forms of one of a triangle shape, a quadrilateral shape, a pentagonal shape, a hexagonal shape, a heptagonal shape, an octagonal shape, and an oval shape.

18. The chuck key of claim 16, wherein the aperture forms of one of a triangle shape, a quadrilateral shape, a pentagonal shape, a hexagonal shape, a heptagonal shape, an octagonal shape, and an oval shape.

19. A chuck key for tightening the jaws of a drill chuck of a chuck, comprising:
a pin for engaging the chuck;
a bevel gear having a plurality of cogs arranged concentrically around a central axis for engaging cogs of the chuck, wherein the gear includes a cavity having a same center of axis as the gear, wherein the cavity forms of one of a triangle shape, a quadrilateral shape, a pentagonal shape, a hexagonal shape, a heptagonal shape, an octagonal shape, and an oval shape;
a protrusion opposite the pin, wherein the protrusion comprises more than four exterior sidewalls and an aperture, wherein the aperture forms of one of a triangle shape, a quadrilateral shape, a pentagonal shape, a hexagonal shape, a heptagonal shape, an octagonal shape, and an oval shape; and
wherein the protrusion, the gear, and the pin have a same center of axis.

20. The chuck key of claim 19, wherein the cavity is differently shaped than the aperture of the protrusion.
